(19) United States
(12) Patent Application Publication
(10) Pub. No.: US 2023/0260283 A1
(43) Pub. Date: Aug. 17, 2023

(54) REMOTE VISUAL INSPECTION GUIDANCE

(71) Applicant: Roke Manor Research Limited, Romsey (GB)

(72) Inventors: William Hamish Crackett, Romsey (GB); Luke Mace, Romsey (GB); Olukayode Sonaike, Romsey (GB); Harold Michael Uzzell, Romsey (GB); Michael William Hodgson, Romsey (GB)

(21) Appl. No.: 18/110,563

(22) Filed: Feb. 16, 2023

(30) Foreign Application Priority Data
Feb. 17, 2022 (GB) 2202161.2

(51) Int. Cl. G06V 20/40; G06V 10/77; G06T 7/73

(52) U.S. Cl. CPC G06V 20/46; G06V 10/7715; G06T 7/73; G06T 2207/10016

(57) ABSTRACT

A method for guiding a remote visual inspection device along an inspection path defined by a pre-stored inspection path-defining image group, from a current position to a target position, includes capturing the live image feed from the remote visual inspection device from the current position during an inspection of an object; matching features of the live captured image to image features in the pre-stored inspection path-defining image group; identifying a key-frame image which is the next closest image in the path-defining image group corresponding to the target position; estimating a transform between the live captured image and next key-frame image, using a transformation estimation method; and generating guidance instructions, based on the transform, and outputting the guidance instructions to enable the device to be moved along the inspection path to the target position.

### CROSS-REFERENCE TO RELATED APPLICATIONS

This application claims priority to and the benefit of United Kingdom Application No. 2202161.2, filed Feb. 17, 2022, which is incorporated herein by reference in its entirety.

### BACKGROUND

The present invention relates to the remote visual inspection of an object, for example using a video probe, video borescope, or remotely operated cameras.

It is commonplace to carry out visual inspections of components within a complex machine using remote visual inspection devices as part of their maintenance. This has shown to be effective compared with disassembling such a machine in order to carry out such an inspection. It is particularly important to carry out such inspections on safety critical machines, such as aircraft engines.

In such machines, inspections must be carried out at defined intervals, and those inspections must be made of particular components of the machine.

### SUMMARY

According to a first aspect of the present invention, a method for guiding a remote visual inspection device along an inspection path defined by a pre-stored inspection path-defining image group, from a current position to a target position comprises: capturing the live image feed from the remote visual inspection device from the current position during an inspection of an object; matching features of the live captured image to image features in the pre-stored inspection path-defining image group; identifying a key-frame image which is the next closest image in the path-defining image group corresponding to the target position; estimating a transform between the live captured image and next key-frame image, using a transformation estimation method; and generating guidance instructions, based on the transform, and outputting the guidance instructions to enable the device to be moved along the inspection path to the target position. Assisting in the positioning of the remote visual inspection device makes it possible to improve the repeatability of inspections, to increase the efficiency of inspections because an optimum inspection path can be calculated, and to remove the requirement of a highly skilled inspectors to operate the remote visual inspection device.

Preferably, the method further comprises extracting all feature data from the live captured image before matching it.

In a preferred embodiment, the steps are repeated until the remote visual inspection device reaches the target position.

The method can advantageously include the step of generating guidance markings on the display of the remote visual inspection device. In this case, the guidance markings can be on-screen lines oriented to indicate the direction the device must be moved, and the lines can extend between feature points in the key-frame and corresponding feature points in the live captured image. The lines can helpfully be arrows.

In another embodiment, the method further comprises an autonomous device driver for moving the remote visual inspection device along the inspection path.

The method may further comprise loading the inspection path-defining image group captured during a previous inspection.

According to a second aspect of the present invention, a remote visual inspection device arranged to be moved along an inspection path defined by a pre-stored inspection path-defining image group, from a current position to a target position, the device comprises: a video camera arranged to capture the live image feed from the current position during an inspection of an object; a feature matcher arranged to match features of the live captured image to features of images in the inspection path-defining image group, the feature matcher being used to identify a key-frame image which is the next closest image in the image group corresponding to the target position; a transformation estimator arranged to estimate a transform between the live captured image and the next key-frame image, using a transformation estimation method; and a guidance generator arranged to generate guidance instructions for the movement of the device based on the transform, and arranged to output the guidance instructions to enable the device to be moved to the target position.

Preferably, the device further comprising a feature extractor arranged to extract feature data from the live captured image for the feature matcher to match.

The device may further be arranged to operate repeatedly until the remote visual inspection device reaches the target position.

In one embodiment, the device further comprises a display, and a guidance marker arranged to generate guidance markings on the display of the remote visual inspection device. In this case, the guidance markings can be on-screen lines oriented to indicate the direction the device must be moved. The lines can be arranged to extend between feature points in the key-frame and corresponding feature points in the live captured image. The lines can be arrows.

In another embodiment, the device further comprises an autonomous device driver for moving the remote visual inspection device along the inspection path.

According to a third aspect of the present invention, a method of creating an inspection path for inspecting an object using a remote visual inspection device comprises: capturing a video stream of a series of images of the object in an initial inspection using the remote visual inspection device; extracting features of the object shown in the images from the video stream; matching the extracted features from the images with the extracted features from others of the images; estimating a transform between one image and the next image in the series, using a transformation estimation method operating on the matched features of those images; and selecting a subset of images from the series of images which include features of the object which are present in both the previous and subsequent images, the subset of images defining an inspection path-defining image group of key-frames.

Preferably, the method further comprises removing mismatched features.

Advantageously, the inspection path-defining image group are the minimum number of key-frames required to allow a repeat navigation using the technique of this invention.

The method may further comprise identifying additional images displaced from the inspection path and generating a recovery path to assist a user following the inspection path back to it if they drift from it. The metrics used for identifying a match can be tightened or loosened.

According to a fourth aspect of the present invention, an inspection path-defining image group of key-frames defining an inspection path for inspecting an object using a remote visual inspection device obtained using the method of the third aspect of the invention.

An embodiment of the present invention will now be described by way of example only with reference to the following drawings:

### BRIEF DESCRIPTION OF THE FIGURES

FIGS. 1 to 3 are screenshots from a remote visual inspection device according to the present invention showing the surface of an object under inspection with a target shape overlaid on the image of the object and a current shape overlaid on the image, and indicating translation, rotation and scaling movement required of the device respectively.

FIG. 4A to 4F are a series of target shape overlays and current shape overlays which indicate different movements required of the remote visual inspection device to guide it along an inspection path.

FIG. 5 is a block diagram of a remote visual inspection device according to one embodiment.

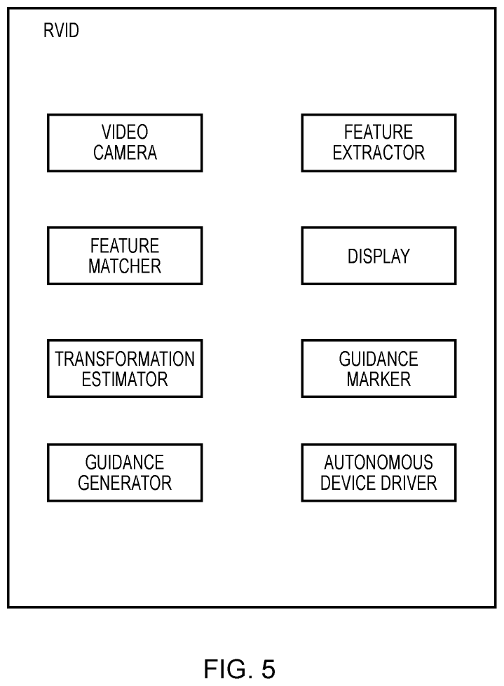

### DETAILED DESCRIPTION

As it currently stands, carrying out remote visual inspections requires the use of highly skilled and specialised inspectors who are trained to carry out inspections which identify any defect of the machine. For example, if an inspector is tasked with inspecting a specific component within the machine, the inspector will know into which access point a remote visual inspection device is to be inserted. The inspector will also know how to route it through the machine until the component to be inspected is reached. The inspector orientates the optical sensor of the remote visual inspection device in order to obtain an image of the component which enables a part of the component to be assessed. The inspector can then move the inspection device in order to make an assessment of another part of the component. Most remote visual inspection devices will include a display screen that the inspector can use to make the assessment. Furthermore, it is commonplace to record an image of the component at each position in order to build a digital library of the inspections undertaken on a machine, or a part of the machine. If the remote visual inspection identifies a component with a defect, that component can undergo maintenance.

It will be appreciated that inspecting a machine is very time-consuming since there are a lot of components to be inspected. There is a high cost associated, not only with the inspection itself, but with the loss of operation of the machine in which the machine is installed. The present invention seeks to reduce the time and costs associated with carrying out remote visual inspections.

Further, it is important that the inspection is done repeatably so that consistency of inspection is ensured between parts of the same machine and between embodiments of the same machine type.

Remote visual inspection of an object is caried out using a remote visual inspection device such as a video probe, video borescope, remotely operated cameras, robotic crawlers or other specialised imaging tools. The resolution of the imaging hardware is required to only be enough as to detect multiple visual features and therefore standard image resolutions will be sufficient. The frame rate of the imaging hardware does not matter to the techniques described in this document providing each successive captured image of the initial inspection contains several visual features that are also present in its previous captured image. The frame rate therefore only limits the speed at which inspections can be conducted. In the embodiment described below, a video borescope is used by way of example. To enable an object to be inspected, three steps must be followed. First, initial inspection of the whole or part of the object must be carried out by a skilled specialist inspector using a remote visual inspection device to capture data of the inspection. Second, the data is processed to create an inspection path. Third, a subsequent guided inspection of an object of interest of the same type is carried out. The object under inspection in the subsequent inspection can be the same object as inspected in the initial inspection, maybe carried out after a period of operation of the object, or the same object in a different machine. Typically the object under inspection is a component within a complex machine.

### 1. Initial Inspection and Image Capture

A highly skilled inspector operates a remote visual inspection device to an initial position. The inspector will then orientate the remote visual inspection device (adjusting the rotation of the remote visual inspection device, its insertion into the machine, and the angle from which the object is viewed) to the particular part or parts of the component to be inspected by the viewing of it on screen. The whole inspection from the view of the remote visual inspection device is recorded (each image from the live video stream) and the images are used to inspect the component(s) of interest is/are flagged—‘target frames’. The target frames can be marked by the inspector during the inspection, or can be identified afterwards. All images are collected with a timestamp.

If additional data is available from the remote visual inspection device, such as inertial data, control commands or local position estimates, then it can be recorded and used to enhance the later processing, however only image data is required for the technique of this invention

All of the data captured is stored, for example in a file or files relating to the particular inspection process carried out, including the type of inspection, the target frames, the date and time of the inspection and of each image in the video stream, the asset being inspected, the sequence of the images, inertial measurements from any accelerometers, and the actuation commands from the controls of the remote visual inspection device if available.

### 2. Image Processing—Creating an Inspection Path

Once the initial inspection and image capture step has been completed, the data is processed in order to create an inspection path, or breadcrumb trail, in terms of the transforms required of the remote visual inspection device to move from the initial position, to the target position(s) though the registration and identification of key frames from the captured image sequence.

The first process is the extraction of all feature data present in each image in the video stream, storing a descriptor of each feature, each key point and its associated image number and timestamp in a suitable format. There are a number of different techniques available for doing this. The technique used in the present embodiment is scale-invariant feature transform (SIFT) in which key points of objects are identified which correspond to points of high contrast in the image which tends to correspond with the edge of an object shown in the image, or to a significant change in the contours of the object.

The second process is the matching of feature data between frames. The extracted feature data of a second image is assessed against the extracted feature data of a first, preceding, image so as to identify all likely matches. There are several techniques for doing this. In this embodiment, we are using Fast Library for Approximate Nearest Neighbours (FLANN Matching). The likeness between each pair of features under review will be used to accept or reject a feature match. The likeness limit upon which this decision is made will be tuned so that different objects of the same type can still register matches even with differences in surface texture and structure caused by effects such as rust, dirt, lighting and defects.

In some instances, it will be appropriate to carry out feature matching not just on adjacent images, but on a wider range of images because some same features may appear in several different images. The metrics for a match can be tightened or loosened depending on the condition of the component and machine being inspected.

The third process is the removal of mismatched features. The conformity between a set of matches and the matches as a whole is assessed to identify false matches. In this embodiment, we are using Random Sample Consensus (RANSAC).

The fourth process is that of image registration where, with a set of feature matches between images, a transform is estimated between one image and the next image in the inspection process which can be used to help guide the later inspection. In this embodiment, we are using Homography Matrix Estimation to identify the transformation between the two images incorporating the translation, roll, yaw, pitch, and scale information that is required. That information can then be used to create guidance markings on the image shown on the remote visual inspection device for guidance of that device to the next image in the inspection process. The transform data is stored along with the data captured in the initial inspection and with the data from the earlier image processing steps.

The fifth process is the removal of similar images, the classification of stored frames and the storage of pre-extracted features to reduce the amount of stored data, and to improve inspection and processing efficiency. The video stream contains a very large number of images, most of which will be very similar, and so many images can be discarded. The key-frames are identified at this point too, if not already done during the inspection. The ‘key-frames’ are the minimum number of frames required to allow a repeat navigation using the technique of this invention. The key-frames do have to include features of the object which are present in both the previous and subsequent images. The key-frames form a breadcrumb trail of images to be followed to move from one target frame to another along an inspection path. ‘Additional frames’ can also be identified during this process to assist the user back to the optimal inspection path between target frames if they drift from it. Associated feature data/additional frames will only be queried if the user strays so far from the inspection path that the current image does not contain any features from ‘key-frames’ and therefore requires additional information to re-acquire a ‘key-frame’.

Additional inspections of a given type of object can be conducted, as described above, and the data from those additional inspections can be captured and used to optimise the selection of key-frames, to add new key-frames, or to add additional frames for assisting in guidance of the remote visual inspection device from one target frame to the next.

### 3. Subsequent Assisted Inspection

In advance of carrying out a subsequent assisted inspection, software is downloaded to the remote visual inspection device, to provide visual guidance to an operator during the assisted inspection to collect all of the images which are required for that inspection to be carried out. Then data is downloaded into the remote visual inspection device from the initial inspection. For example, if the inspection is to be carried out on a part of a component of a particular type of machine, the file relating to this inspection is downloaded.

The operator moves the remote visual inspection device to a start point corresponding to a first key-frame from the initial inspection. The live video data from the current inspection is continuously compared with the stored data (image features) to find the live inspection position. This is done by feature matching and image registration as described above in the section “2. Image Processing—Creating an Inspection Path”.

The estimated transformation between the live image and the next key-frame in sequence is used to guide the user along the inspection path towards the target position. The estimated transform between the current frame and the next key-frame is used to generate guidance markings on the screen of the remote visual inspection device representing the rotation, translation and scale transition between the current image and the key frame. These guidance markings are overlaid on the live image shown on the remote visual inspection device, and could take a number of forms. In this embodiment, guidance markings include a number of arrows which represent vectors indicating the direction of movement required from the remote visual inspection device to reach the next key frame. The arrows start at feature points in the target key frame and end with an arrowhead on the corresponding feature point in the current image. The arrows are therefore arranged so that, as the location of the next key frame becomes closer, they become shorter on the screen, but if the operator moves the remote visual inspection device further away from the next key frame, the arrows become longer on the screen to emphasise that the operator is moving the remote visual inspection device in the wrong direction. The direction of the arrows is dynamic so that, as the remote visual inspection device moves, the direction of the arrows changes to account for displacement of the remote visual inspection device away from the inspection path. Once the remote visual inspection device is in close enough proximity to the current key-frame, the next key-frame in sequence is used. If the next key-frame is the target frame then the vectors will continue to show the translation for that target frame until a close enough match is achieved, where the user will be notified to store that image for the inspection. The proximity in which a key-frame updates and/or the target frame is matched can be set by the user for each type of inspection.

In addition to the arrows, or as an alternative to them, a shape is overlaid on the live image displayed on the screen to give guidance along the inspection path and assist with alignment of the image. In this case, the shape is a rectangle in landscape orientation, and the shape is positioned centrally on the screen so that, as the remote visual inspection device moves, the shape remains on the screen in the same position, with the live image moving past it. I shall refer to this as the ‘current shape’ because it is the shape overlaying the live, current image shown on the screen.

There is a second rectangular shape visible on the screen which is projected onto the image overlaid on the object being inspected corresponding to the position and orientation the current shape must be moved to in order to move the remote visual inspection device to the next key frame. This is the ‘target shape’, and as the remote visual inspection device moves, the image of the object being inspected will move across the screen with the target shape moving superimposed on the object.

The operator of the remote visual inspection device moves the device, following the inspection path until the current shape substantially aligns with the target shape. If the key-frame is a target frame, the device is able to collect an image corresponding to the target frame. In any event, once the images are substantially aligned, new guidance markings appear guiding the device to the next key-frame.

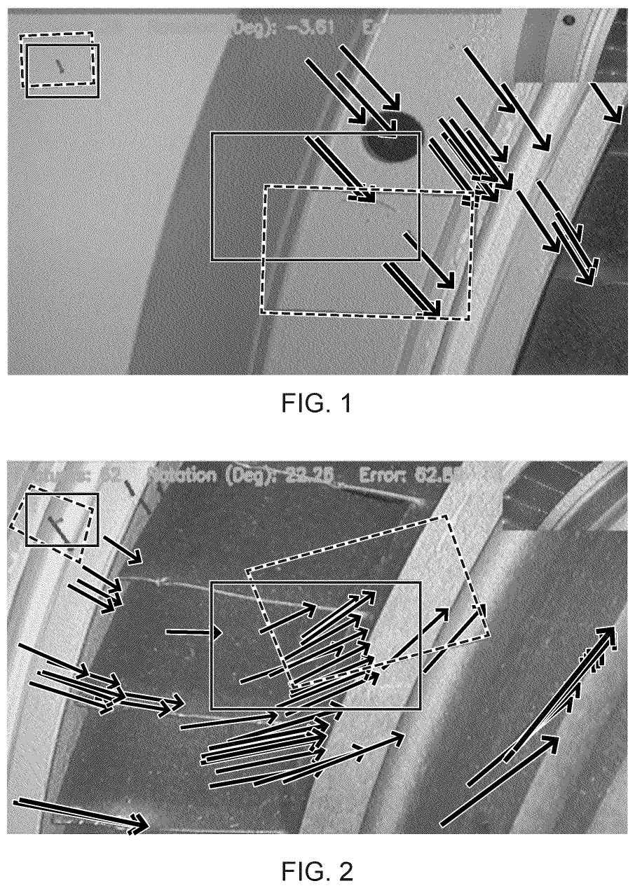

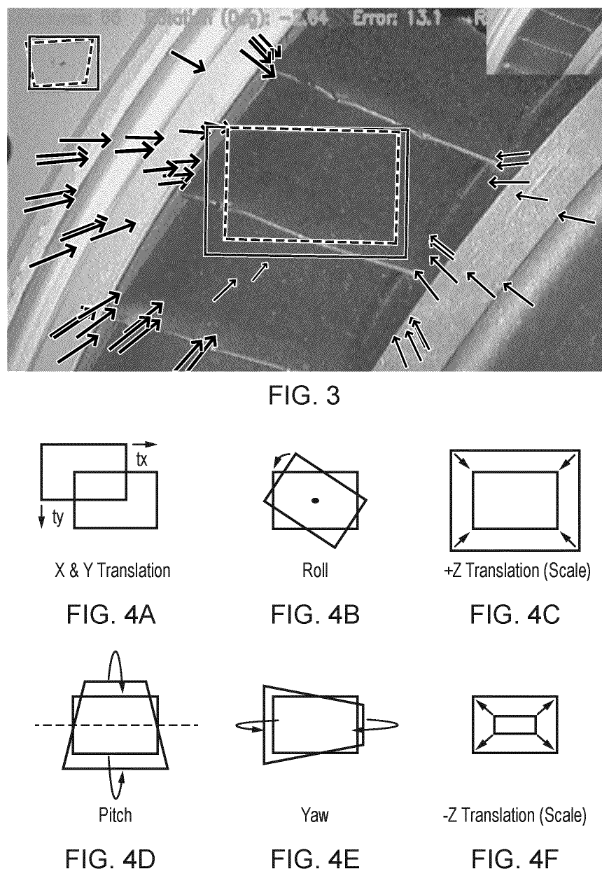

FIG. 1 shows the screen of a remote visual inspection device where the operator is moving it towards a key-frame which is also a target frame, where an image is collected. The first thing to note is that it includes a number of arrows pointing down and to the right indicating the direction in which the device must be moved to match the next image. In this case, because the two rectangular shapes are the same size and orientation, it is simply necessary to translate the remote visual inspection device down and to the right until the current shape overlies the target shape. The image can then be collected with very high certainty that it matches the corresponding image in the initial inspection. This translation guidance is also represented in FIG. 4A.

FIG. 2 shows the screen of a remote visual inspection device where the operator is moving it towards a key frame which is also a target frame, where an image is collected. It includes a number of arrows pointing anti-clockwise indicating the direction in which the device must be rotated to match the next image. In this case, because the two rectangular shapes are the same size and position, but with the current shape deformed so that it is angularly displaced relative to the target position, it is simply necessary to manipulate the remote visual inspection device in an anticlockwise direction until the current shape overlies the target shape. The image can then be collected with very high certainty that it matches the corresponding image in the initial inspection. This rotation guidance (Roll) is also represented in FIG. 4B.

FIG. 3 shows the screen of a remote visual inspection device where the operator is moving it towards a key frame which is also a target frame, where an image is collected. It includes a number of arrows pointing inwards indicating the direction in which the device must be moved to match the next image. In this case, because the two rectangular shapes are different sizes, it is necessary to manipulate the remote visual inspection device towards the object until the current shape overlies the target shape. The image can then be collected with very high certainty that it matches the corresponding image in the initial inspection. It will also often be necessary to move further away from the object being inspected so that the scale of the image is substantially the same as in the equivalent initial inspection image. Examples of both scale adjustments are shown in FIGS. 4C and 4F. In FIG. 4C, the remote visual inspection device is too far away from the object, and must be moved closer. The current shape is shown deformed, enlarged relative to the target shape. The operator must move the device towards the object in order to move the device into the appropriate position to capture the next image at the correct scale, and as it is moved towards the object, the current shape gradually shrinks until it is the same size as the target shape, whereupon the image can be taken. In FIG. 4F, the device is too close to the object, and must be moved back, and this is indicated by the fact that the current shape is deformed, smaller than the target shape. As the device is moved away from the object, the current shape enlarges until it is the same size as the target shape, whereupon the image can be collected at the correct scale.

Referring to FIG. 4, it will be seen that there are a number of additional ways in which the device is manipulated in order to collect the appropriate image. It will sometimes be necessary to effect a pitch or yaw movement in order to align the current shape with the target shape, and in this case, the target shape is shown with its major and minor axes perpendicular to the horizontal and vertical axes of the screen, and the current shape is shown deformed, angularly rotated with respect to the screen. Alignment of the two shapes is effected by pitching or yawing the device until the rectangles align, and then the image can be collected.

In FIG. 4D, the device requires a pitch movement, and this is indicated by the current shape being deformed, a trapezium (a quadrilateral with at least one pair of parallel sides, known in the US as a trapezoid) which is narrower at the top than at the bottom. The operator must manipulate the device so that it applies pitch movement. This will cause the current shape to become rectangular and aligned with the target shape. Another way of looking at this is that it requires the device to be rotated around a horizontal axis until it is at the correct pitch. FIG. 4E shows a similar situation as in FIG. 4D, except that the device requires a yaw adjustment, as denoted by the current shape being deformed as a trapezium with the left edge of the parallelogram being longer than the right. The operator must manipulate the device to apply a yaw movement. This will cause the current shape to become aligned with the target shape. Another way of looking at this is that it requires the device to be rotated around the vertical axis until it is at the correct yaw angle.

The deformation of the target shape is generated from the current shape using the estimated transformation between the current and target images. These overlaid shapes will intuitively communicate to the operator the translation, rotation or scaling action that is required to move from the current image to the target image. By updating the display with each new inspection hardware measurement will allow the user to observe live feedback as to whether the actions taken bring the remote visual inspection device closer or further away from the target by the arrows shortening, or by the current shape becoming less deformed.

In this embodiment, the shape of the current and target shapes is a rectangle, but other shapes could be used instead.

In this embodiment, it is the target shape which is deformed to guide the device towards the target image, but the current shape could be deformed instead.

In a second embodiment, the remote visual inspection device is autonomous in that it can move without human control. The first two steps of Initial Inspection and Image Capture; and Image Processing remain unchanged. In the third step, the transforms can be interpreted by a computer implemented autonomous system to move the device from one key frame to the next by operating the controls of the device in order to effect translation, rotation and scaling, movements to place it in position to collect the next image.

1. A method for guiding a remote visual inspection device along an inspection path defined by a pre-stored inspection path-defining image group, from a current position to a target position, the method comprising:
capturing the live image feed from the remote visual inspection device from the current position during an inspection of an object;
matching features of the live captured image to image features in the pre-stored inspection path-defining image group;
identifying a key-frame image which is the next closest image in the path-defining image group corresponding to the target position;
estimating a transform between the live captured image and next key-frame image, using a transformation estimation method;
generating guidance instructions, based on the transform, and outputting the guidance instructions to enable the device to be moved along the inspection path to the target position.

2. The method according to claim 1, further comprising extracting all feature data from the live captured image before matching it.

3. The method according to claim 1, comprising repeating the steps until the remote visual inspection device reaches the target position.

4. The method according to claim 1, further comprising generation of guidance markings on the display of the remote visual inspection device.

5. The method according to claim 4 wherein the guidance markings are on-screen lines oriented to indicate the direction the device must be moved.

6. The method according to claim 5, wherein the lines extend between feature points in the key-frame and corresponding feature points in the live captured image.

7. The method according to claim 1, further comprising an autonomous device driver for moving the remote visual inspection device along the inspection path.

8. The method according to claim 1, further comprising loading the inspection path-defining image group captured during a previous inspection.

9. A remote visual inspection device arranged to be moved along an inspection path defined by a pre-stored inspection path-defining image group, from a current position to a target position, the device comprising:
a video camera arranged to capture the live image feed from the current position during an inspection of an object;
a feature matcher arranged to match features of the live captured image to features of images in the inspection path-defining image group, the feature matcher being used to identify a key-frame image which is the next closest image in the image group corresponding to the target position;
a transformation estimator arranged to estimate a transform between the live captured image and the next key-frame image, using a transformation estimation method; and
a guidance generator arranged to generate guidance instructions for the movement of the device based on the transform, and arranged to output the guidance instructions to enable the device to be moved to the target position.

10. The device according to claim 9, further comprising a feature extractor arranged to extract feature data from the live captured image for the feature matcher to match.

11. The device according to claim 9, wherein the device is arranged to operate repeatedly until the remote visual inspection device reaches the target position.

12. The device according to claim 9, further comprising a display, and a guidance marker arranged to generate guidance markings on the display of the remote visual inspection device.

13. The device according to claim 12 wherein the guidance markings are on-screen lines oriented to indicate the direction the device must be moved.

14. The device according to claim 13, wherein the lines extend between feature points in the key-frame and corresponding feature points in the live captured image.

15. The device according to claim 9, further comprising an autonomous device driver for moving the remote visual inspection device along the inspection path.

16. A method of creating an inspection path for inspecting an object using a remote visual inspection device comprising:
capturing a video stream of a series of images of the object in an initial inspection using the remote visual inspection device;
extracting features of the object shown in the images from the video stream;
matching the extracted features from the images with the extracted features from others of the images;
estimating a transform between one image and the next image in the series, using a transformation estimation method operating on the matched features of those images;
selecting a subset of images from the series of images which include features of the object which are present in both the previous and subsequent images, the subset of images defining an inspection path-defining image group of key-frames.

17. The method of claim 16, further comprising removing mismatched features.

18. The method according to claim 16, wherein the inspection path-defining image group are the minimum number of key-frames required to allow a repeat navigation using the technique of this invention.

19. The method according to claim 16, further comprising identifying additional images displaced from the inspection path and generating a recovery path to assist a user following the inspection path back to it if they drift from it.

20. An inspection path-defining image group of key-frames defining an inspection path for inspecting an object using a remote visual inspection device obtained using the method of claim 16.

21. A non-transitory computer-readable medium storing instructions executable by a remote visual inspection device, wherein the instructions, when executed, cause to the remote visual inspection device to be guided along an inspection path defined by a pre-stored inspection path-defining image group, from a current position to a target position in accordance with the method of claim 1.
